(19) United States
(12) Patent Application Publication
(10) Pub. No.: US 2006/0117342 A1
(43) Pub. Date: Jun. 1, 2006

(54) Method for acquiring channel information and registering for reception of multicast based IP TV broadcasting in access network

(76) Inventors: Pyung Koo Park, Daejeon-city (KR); Jae Chan Shim, Daejeon-city (KR); Sun Hee Yang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/198,594

(22) Filed: Aug. 4, 2005

(30) Foreign Application Priority Data
Nov. 30, 2004 (KR) 10-2004-0099164

(51) Int. Cl. H04N 7/173; G06F 13/00; H04N 5/445

(52) U.S. Cl. 725/37; 725/112; 725/113; 725/110; 725/111

(57) ABSTRACT

A method for obtaining broadcasting channel information and registering for reception of multicast based Internet protocol (IP) TV broadcasting service in a subscriber network is provided. The method for receiving multicast based IP TV broadcasting service by a terminal connected to a subscriber network through an access router, includes: completing authentication of the terminal and subscriber; accessing a web server providing an electronic program guide (EPG) and receiving information on at least one or more channels permitted to the terminal; providing at least one or more selection units by using graphic user interface (GUI) so that a channel is selected based on the channel information; and according to the selected channel, generating and transmitting a multicast socket. Since the subscriber terminal receives channel information allocated to the terminal in the initial channel selection step, it is appropriate to Internet broadcasting which changes dynamically, and the time for selecting a channel can be reduced.

### CROSS-REFERENCE TO RELATED PATENT APPLICATIONS

This application claims the benefit of Korean Patent Application No. 10-2004-0099164, filed on Nov. 30, 2004, in the Korean Intellectual Property Office, the disclosure of which is incorporated herein in its entirety by reference.

### BACKGROUND OF THE INVENTION

1. Field of the Invention

The present invention relates to information required for a subscriber requesting a broadcasting channel in a subscriber network for Internet protocol (IP) TV broadcasting, and a method for obtaining the information.

2. Description of the Related Art

As demands for the Internet have been rapidly increasing recently, demands for TV broadcasting service through the Internet have also been increasing. Accordingly, efforts to provide multicast based IP TV broadcasting are being briskly made. In providing IP TV broadcasting service using multicast, a subscriber requests multicast traffic for a desired channel, by using an Internet group management protocol (IGMP), and in response, a broadcasting server transmits the requested broadcasting content.

At this time, for the multicast based IP TV broadcasting, the subscriber should have provided channel information such that the subscriber can request a desired broadcasting channel by using the IGMP and receive the broadcasting.

In this respect, according to the conventional technology, a subscriber should have all channel information regardless of an initial access to a network by the subscriber. Also, the server broadcasts channel information that the server can provide, to all subscriber terminals.

However, this conventional method has a drawback that it is not appropriate to dynamic IP TV broadcasting that has a large number of channels, and frequently changing channel information, and cannot provide customized subscriber services.

There is another conventional method by which channel information requested by a subscriber is received from a server whenever a channel is requested. This method also has a drawback that it takes time to select a channel appropriate to broadcasting.

### SUMMARY OF THE INVENTION

The present invention provides a method by which after a subscriber first accesses a subscriber network, channel information is obtained through authentication, and using the obtained information, an Internet group management protocol (IGMP) is transmitted so that broadcasting provided through multicast can be received.

According to an aspect of the present invention, there is provided a broadcasting channel information obtaining and registering method for receiving multicast based IP TV broadcasting service by a terminal connected to a subscriber network through an access router, including: completing authentication of a terminal and a subscriber; accessing a web server providing an electronic program guide (EPG) and receiving information on at least one or more channels permitted to the terminal; providing at least one or more selection units by using graphic user interface (GUI) so that a channel is selected based on the channel information; and according to the selected channel, generating and transmitting a multicast socket.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates registration and maintaining of desired channel information by using an Internet group management protocol (IGMP) in order to receive multicast based Internet protocol (IP) TV service;

FIG. 2 illustrates termination of channel information by the IGMP;

FIGS. 3A and 3B illustrate the flow of a process for obtaining and registering channel information of multicast based IP TV broadcasting in a subscriber network;

FIG. 4 illustrates the structure of subscriber channel information for multicast based IP TV broadcasting service; and

FIGS. 5A through 5F illustrate a method for obtaining and registration of broadcasting channel information according to the present invention, with each operation of the method displayed sequentially on the screen.

### DETAILED DESCRIPTION OF THE INVENTION

The present invention will now be described more fully with reference to the accompanying drawings, in which exemplary embodiments of the invention are shown.

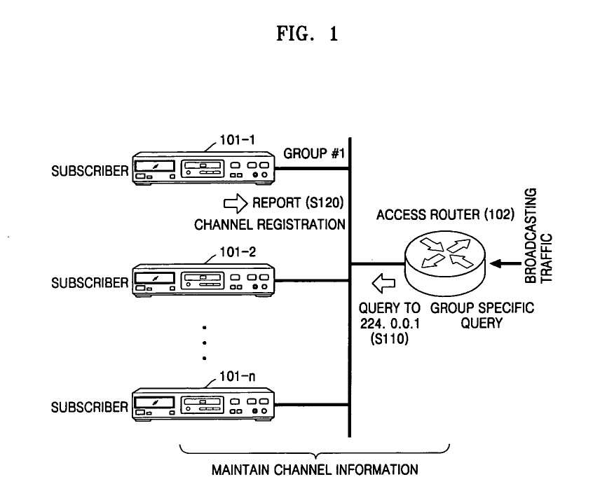

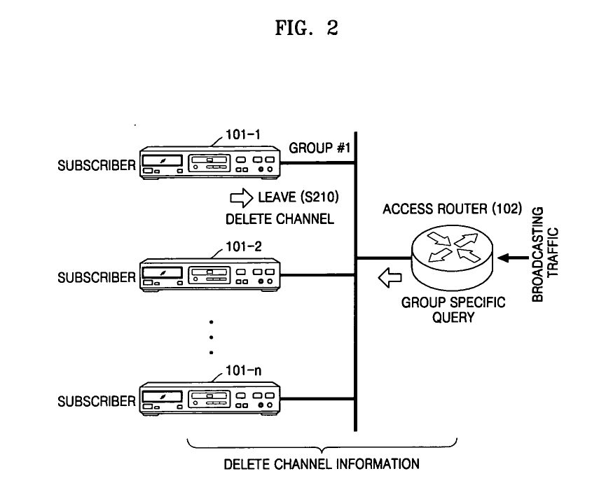

FIG. 1 illustrates registration and maintaining of desired channel information by using an Internet group management protocol (IGMP) in order to receive multicast based Internet protocol (IP) TV service, and FIG. 2 illustrates termination of channel information by the IGMP.

Generally, in multicast based IP TV broadcasting service, broadcasting contents are provided through IP multicast. Subscriber terminals 101-1 through 101-N request desired channels to a subscriber network router 102 (access router, hereinafter “a subscriber network router” will be used as a synonym of “an access router”), by using the IGMP, and receive contents.

For this, a subscriber 101-1 through 101-N informs the subscriber network router 102 receiving broadcasting traffic for reception of multicast based IP TV broadcasting, of information on a desired channel by using the IGMP. That is, the subscriber network router 102 queries multicasting addresses to subscribers connected to it in operation S110, and corresponding subscribers reports to the subscriber network router 102 with a report message to request channel registration in operation S120. At this time, though the IGMP has IGMPv1, IGMPv2, and IGMPv3, channel registration is common to all regardless of the versions.

FIG. 2 illustrates termination of channel information by the IGMP.

When the subscriber 101-1 through 101-N receiving multicast based IP TV broadcasting through the registration process described above with reference to FIG. 1 wants to stop reception of the broadcasting or to select another channel, the existing broadcasting channel is terminated using the IGMP.

For this, the subscriber 101-1 through 101-N transmits a leave message to the subscriber network router 102 in operation S210, and if the message is received, the subscriber network router 102 deletes the channel corresponding to the subscriber sending the leave message. At this time, though the IGMP has IGMPv1, IGMPv2, and IGMPv3, it is preferable to use IGMPv2 and IGMPv3 for channel deletion.

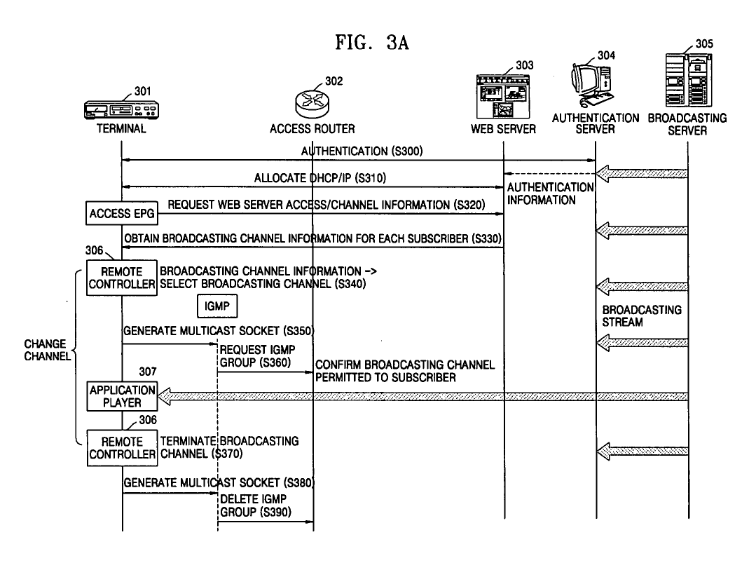

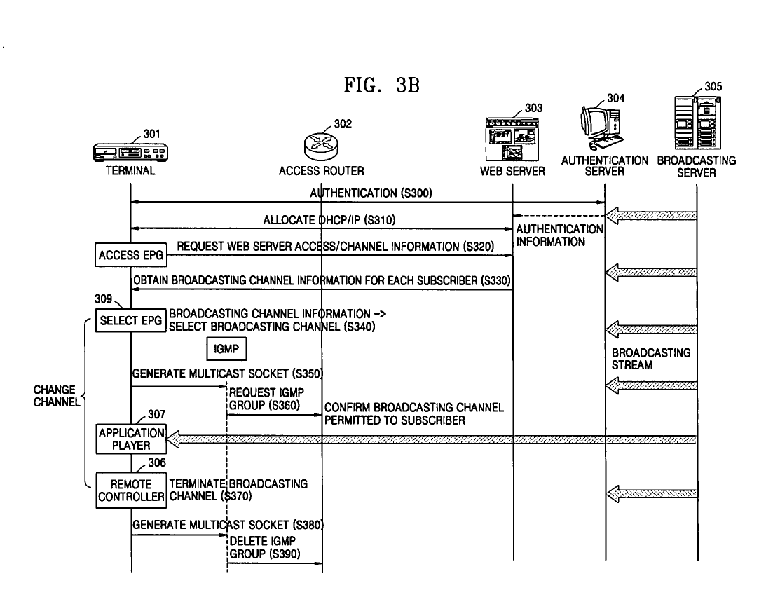

FIG. 3A illustrates performing a method for obtaining channel information and registering for multicast based IP TV broadcasting service in a subscriber network, by using a remote controller (to be explained later), and FIG. 3B illustrates performing the method by selecting an electronic program guide (EPG).

First, a subscriber 301 performs authentication with an authentication server 304 in operation S300. The authentication has a 2-level structure in which after the authentication of the terminal itself succeeds, authentication of the user is performed.

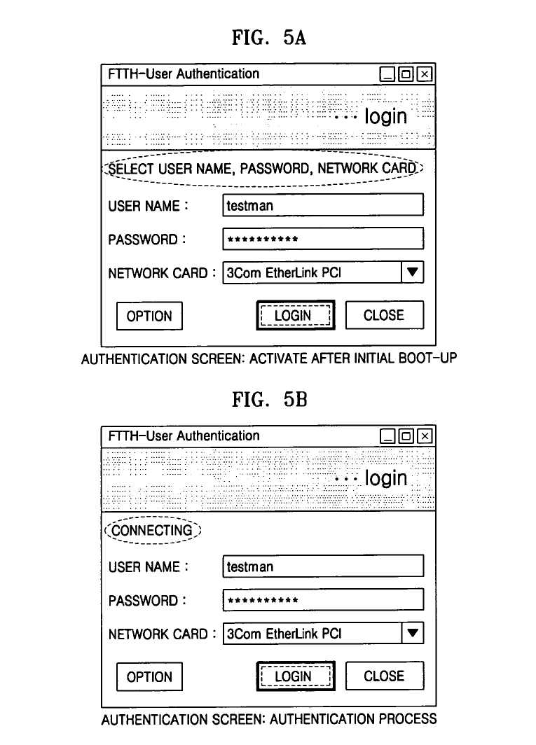

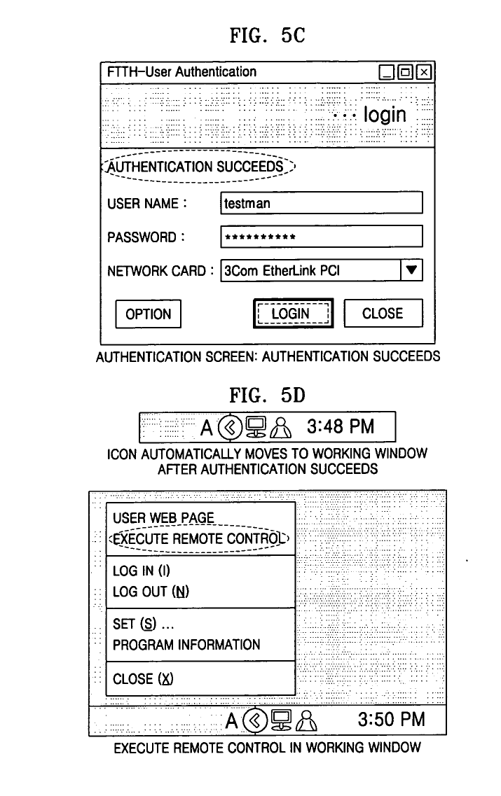

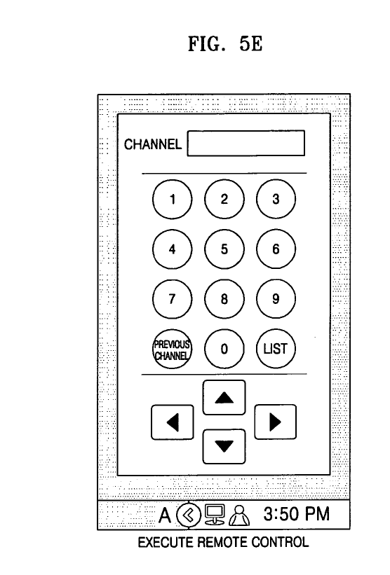

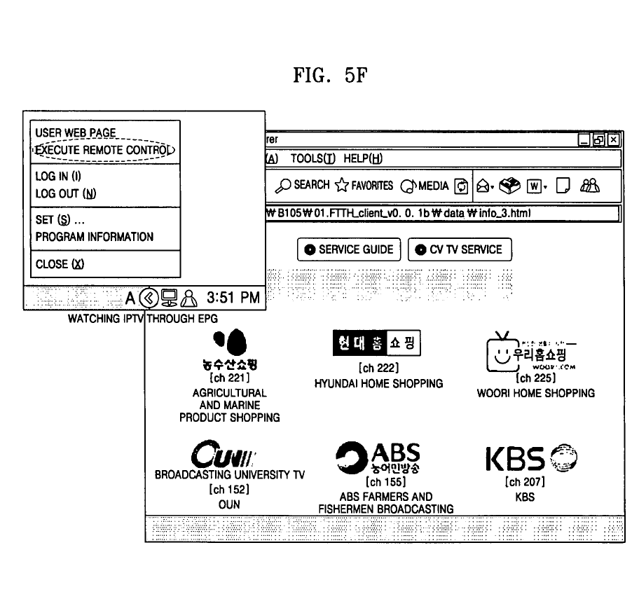

FIG. 5A shows an authentication screen appearing on the screen when the terminal is activated after initial booting. FIG. 5B is a screen appearing during performing authentication after a username and a password are input. FIG. 5C shows a result screen when the authentication is successful. If the authentication is successful, dynamic host configuration protocol (DHCP)/IP is allocated to the terminal 301 in operation S310. Then, the terminal accesses an EPG server 303 and requests channel information in operation S320. The web server 303 transmits information only on a channel permitted to the terminal connected to the web server 303 in operation S330. In the terminal 301 receiving this information, a remote controller can be displayed as a graphic user interface (GUI), after the web server 303 is connected, a channel icon can be displayed on the screen so that the user can select a channel. Referring to FIG. 5D, a menu is provided so that any one of these can be selected.

First, if the remote controller 306 is selected as shown in FIG. 3A, a virtual remote controller as shown in FIG. 5E is displayed on the screen and the user requests a channel permitted to the user by using this remote controller in operation S340.

At this time, a multicast socket is generated in operation S350, and an IGMP group request is transmitted to the access router 302 in operation S360. The access router 302 receiving the request confirms whether the channel is permitted to the subscriber. If the process until that time is legal, then broadcasting transmitted by the broadcasting server 305 is received in real time and is displayed on the screen through an application player 307.

When the broadcasting channel is terminated in operation S370, a broadcasting channel is selected by using the remote controller 306. Then a multicast socket appropriate to this is generated in operation S380, and IGMP group deletion is requested to the access router 302 in operation S390. According to the request, the access router 302 updates the subscriber information in its database.

FIG. 3B illustrates a case where the EPG web is accessed instead of using the remote controller after the authentication.

The entire flow of this case is the same as the case where the remote controller is used described above with reference to FIG. 3A, and the explanation will be omitted here. That is, in an operation indicated by an identical reference number, an identical process is performed. However, the remote controller 306 in FIG. 3A is replaced with connection to the EPG web 309 in FIG. 3B. This makes a difference that a representative icon of each broadcasting channel is displayed on the screen so that the user can see and select this as shown in FIG. 5F.

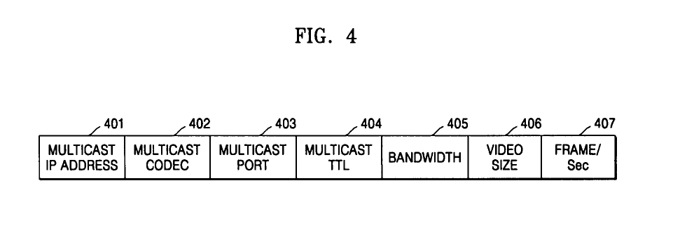

FIG. 4 illustrates channel information maintained for each subscriber for multicast based IP TV broadcasting service according to the present invention. As described above with reference to FIGS. 3A and 3B, subscriber information for IP broadcasting should be transmitted and received between the subscriber terminal 301 and the access router 302. For this, the subscriber terminal 301 needs to register a channel in the subscriber network router 302 for reception of IP multicast broadcasting streams. FIG. 4 shows information required for this and information required for broadcasting output after reception of the broadcasting stream. A multicast IP address 401 is a destination IP address to which broadcasting is transmitted, that is, a destination address of broadcasting data. A multicast codec 402 is a protocol for receiving broadcasting data, and indicates UDP/RTP and the like. A multicast port 403 is a port of a protocol transmitting broadcasting data. A multicast time to live (TTL) 404 is a value set to prevent a phenomenon that broadcasting data is continuously transmitted in a network. A bandwidth 405 indicates the bandwidth for reception of broadcasting, and a video size 406 indicates the size of a broadcasting content. A frame/sec 407 is the transmission rate of broadcasting data.

The method for obtaining broadcasting channel information and registering for reception of multicast based Internet protocol (IP) TV broadcasting service in a subscriber network according to the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

According to the method for obtaining broadcasting channel information and registering for reception of multicast based IP TV broadcasting service in a subscriber network according to the present invention as described above, a subscriber registers a channel in a multicast address allocated to a channel, by using the IGMP for multicast based IP TV broadcasting. Since the subscriber terminal receives channel information allocated to the terminal in the initial channel selection step, it is appropriate to Internet broadcasting which changes dynamically, and the time for selecting a channel can be reduced.

What is claimed is:

1. A broadcasting channel information obtaining and registering method for receiving multicast based IP TV broadcasting service by a terminal connected to a subscriber network through an access router, comprising:
completing authentication of a terminal and a subscriber;
accessing a web server providing an electronic program guide (EPG) and receiving information on at least one or more channels permitted to the terminal;
providing at least one or more selection units by using graphic user interface (GUI) so that a channel is selected based on the channel information; and
according to the selected channel, generating and transmitting a multicast socket.

2. The method of claim 1, wherein in the completing of the authentication, after authentication of the terminal succeeds, authentication of the subscriber is completed.

3. The method of claim 1, wherein in the accessing of the web server and receiving of channel information, the channel information is information on a channel permitted in advance to the terminal for access.

4. The method of claim 1, wherein the channel information comprises a multicast IP address, a multicast codec, a multicast port, a multicast time to live (TTL), a bandwidth, a video data size, and a frame rate per second.

5. The method of claim 1, wherein in the providing of the selection units, a virtual remote controller is displayed on a display apparatus or a web site providing an electronic program guide (EPG) is accessed, and a selectable channel is displayed as an icon so that the GUI is provided to the user.

6. The method of claim 1, wherein the generating and transmitting of the multicast socket further comprises:
generating the multicast socket based on an Internet group management protocol (IGMP) and requesting an IGMP group.

7. A computer readable recording medium having embodied thereon a computer program for a method for receiving multicast based IP TV broadcasting service by a terminal connected to a subscriber network through an access router, wherein the method comprises:
completing authentication of the terminal and subscriber;
accessing a web server providing an electronic program guide (EPG) and receiving information on at least one or more channels permitted to the terminal;
providing at least one or more selection units by using graphic user interface (GUI) so that a channel is selected based on the channel information; and
according to the selected channel, generating and transmitting a multicast socket.
